(19) United States
(12) Patent Application Publication
(10) Pub. No.: US 2015/0070928 A1
(43) Pub. Date: Mar. 12, 2015

(54) MODULE FOR DISPLAYING PRODUCTS WITH BACK-LIGHTING FUNCTION, FRONT MODULE THEREOF AND PRODUCT DISPLAY UNIT

(71) Applicant: GESA Form + Funktion Displaybau GmbH, Dreieich-Offenthal (DE)

(72) Inventor: Otmar RAU, Dreieich-Gotzenhain (DE)

(21) Appl. No.: 14/314,129

(22) Filed: Jun. 25, 2014

(30) Foreign Application Priority Data
Sep. 11, 2013 (DE) 20 2013 104 137.8

(51) Int. Cl. A47F 3/00; F21V 8/00

(52) U.S. Cl. CPC A47F 3/001; G02B 6/0081
USPC 362/604

(57) ABSTRACT

A front module for a portion for supporting products of a product display unit is configured to be disposed at the front end of the portion for supporting products and has a front side configured for displaying text and/or graphics information to customers. The front module has a planar light guide plate to which a light source is associated so that light from the light source is coupled into the light guide plate, wherein the light guide plate is configured to provide a back-lighting for the text and/or graphics information to be displayed on the front side of the front module. The front module enables an efficient and attractive product display. The back-lighting enables display of text and/or graphics information. The light emitted from the light guide plate can be used directly for the illumination of products and the direction of the light emission can adjusted as desired.

The present application claims the priority of German Utility Model No. 20 2013 104 137.8 ‘Module for displaying products with back-lighting function and product display unit’, filed on 11 Sep. 2013, the whole content of which is hereby incorporated by way of reference.

### FIELD OF THE INVENTION

The invention relates generally to the displaying or presentation of products, such as cosmetic products, by means of back-lighting and relates in particular to modules embodied as a shelf plates for units for displaying products and their use for units for displaying products.

### BACKGROUND OF THE INVENTION

Units for displaying products of the aforementioned type, also named shelf/module in the prior art, are set up as part of sales counters (also named display), in sales outlets such as supermarkets or drugstores and offer the option to the customer to display a specific product, such as a cosmetic product. The finished shelf/module as part of a display is, for example, set up in a drugstore, department store, perfumery or the like and displays products (such as cosmetic products) for sale to the final consumer. The final product is available in different optics in accordance with customer requirements.

The product can be regarded in this case as part of a display, but could also stand alone in other embodiments.

Suppliers of cosmetic products often have their own display units installed in stores, in which they display their products in a uniform manner. As part of such display units shelf plates/modules are required, on the one hand, for accommodating or supporting the products and, on the other hand, for displaying the products.

So far shelf plates/modules are manufactured individually in accordance to the customer requirements by means of plastics processing (e.g. using thermoforming, injection molding). These shelf plates/modules usually had to be equipped with many different light sources (e.g. LEDs) for illumination purposes.

For a more effective and more attractive displaying of products it has been convenient to use modules, especially in the field of cosmetic products, which are provided with shelf plates or supporting plates made of a transparent material, such as transparent plastic, which enable a backlight function for back-lighting products to be displayed. The shelf plates or supporting plates serve as a light guide from which the light is coupled out in an appropriate manner for back-lighting of the products.

Particularly for the displaying of products there is a need for aesthetically designed modules, which, on the one hand, can be produced at low costs and can be configured in a flexible manner and which, on the other hand, are sufficiently robust.

DE 102010050417 A1 discloses a shelf rail for labeling products having a projecting portion on the underside of which an LED light source is mounted, which emits light downwards. A coupling of light into a light guide plate is not disclosed.

DE 20208161 U1 discloses a transparent shelf for displaying products which is equipped with a plurality of LEDs so that light is emitted both upwards and downwards in the front area. A coupling of light into light guide plates in the sense of the present application is not disclosed.

DE 20211858 U1 discloses a plate-shaped shelf plate made of glass having a transverse profile at the front edge at which a fluorescent lamp is disposed. The shelf plate radiates the light upward and downward. A backlight function on the front end is not disclosed.

U.S. Pat. No. 1,839,287 discloses the coupling of light from a light source into the faces of two transparent light guide plates, which are each provided with patterns. The general structure, however, is fundamentally different to that of the present application.

### SUMMARY OF THE INVENTION

It is an object of the present invention to provide a novel front module for units for displaying products, particularly for cosmetic products, and furthermore a module comprising such a front module, which can be designed stylish, can be produced at low costs and can be configured in a flexible manner and is robust enough in use. Furthermore, a product display unit (unit for displaying products) is to be provided comprising at least one such module.

According to the invention, there is provided a front module for a portion for supporting products of a product display unit, in particular for a portion for supporting products of a module for a product display unit, wherein the front module is configured to be provided (or positioned) at the front end of the portion for supporting products, wherein said front module has a front side configured for displaying text and/or graphics information for customers. According to the present invention, the front module comprises a planar light guide plate having a light source associated to it so that light from the light source is coupled into the light guide plate, particularly into a face or a light-deflecting portion thereof. Furthermore, the light guide plate is configured to provide a back-lighting function for said text and/or graphics information at least in sections at the front side of said front module. Because the front module offers a backlight function at its front side in the manner of a backlighting emitted from the surface of the light guide plate, according to the invention products can be displayed even more efficiently and in a more attractive manner. In particular, by means of the back-lighting promotional text and/or graphics information can be displayed in a simple way on the front end of the front module. The light emitted from the light guide plate of the front module may further also be used directly for the illumination of products. By suitably shaping the light guide plate of the front module also the direction of the light emission can be adjusted in a suitable manner. In particular, products or portions of a unit for displaying products disposed below and/or above the front module can be illuminated in a suitable manner by means of the light guide plate of the front module. Here, the light guide plate may also be curved at least in sections, and the light may also be emitted from edges and/or curved portions of the light guide plate.

The planar light guide plate of the front module provides for a uniform back-lighting, at least over the entire region in which the text and/or graphics information is to be backlit. Advantageously, this region extends over the entire width or almost the entire width of the front module, which may extend over the entire width or almost the entire width of the portion for supporting products in its turn. The text and/or graphics information can be applied directly to the front of the front module, for example by means of a printing or bonding process.

Conveniently, the light guide plate of the front module is made of a transparent plastics material (such as PMMA, polycarbonate or epoxy resin), e.g. by means of plastic injection molding or extrusion from a suitable plastics material. Conveniently, the light of the associated light source, in particular of a plurality of LEDs or of an LED strip comprising a plurality of such LEDs, is coupled into the front end of the light guide plate or of a light-deflecting portion thereof. The light guide plate comprises structures for coupling-out light that couple the light out from the light guide plate at a suitable location for the back-lighting. This coupling-out may be accomplished by means of scattering structures or particles that are distributed in the light guide material, by means of tiny surface structures or tiny printed patterns, e.g. embodied as grooves, projections or recesses. Furthermore, by adding light-guiding additives the light-guiding characteristics of the light guide plate from plastics material may be further enhanced. Furthermore, a so-called diffuser film, which controls the light scattering effect, may be applied on the top surface of the illuminated plastic plate. The inhomogeneous distribution of the structures for coupling-out causes that the uniform illumination of the surface e.g. is also accomplished by coupling light into only one of the end faces of the light guide plate. To further enhance the luminance, the light sources may in general also be provided at two or more end faces; in the case of the portion for supporting products particularly at two or more end faces of the supporting plate of the portion for supporting products. A back-lighting according to this principle is referred to in English language as edge-lit backlight.

In order to accomplish a reliable support or accommodation of the products by the portion for supporting products, the latter may be especially shaped like a box, comprising raised side portions extending along the edges for preventing slippage of the products to be displayed. Or sleeve-like receptacles are provided or formed on the shelf plate (supporting plate), preferably made of a transparent or opaque material, in which the products to be displayed may be reliably accommodated.

According to a further embodiment the front module is further configured to delimit the portion for supporting products at least in sections, for preventing slippage of products from the portion for supporting products, when the front module is connected to the portion for supporting products. For this purpose, the front module may be particularly configured such that, if it is connected to the portion for supporting products, it projects beyond a plane spanned by the portion for supporting products that is used for storage of products in the portion for supporting products, e.g. projecting perpendicular or under an acute angle from this plane. Thus, under normal use conditions, the portion for supporting products does not necessarily need to be oriented exactly horizontally, but may also be arranged inclined, particularly inclined downward towards the front end of the product display unit.

According to a further embodiment, the light guide plate extends in a different direction in at least one area to form at least one light-deflecting portion for deflecting the light coupled into the light guide plate in a different direction of propagation. Light for a back-lighting can thus be emitted into at least two different directions, which may further enhance the effectiveness in advertising of the front module at an even lower energy consumption. Due to this design, the front module can emit light into more than one spatial direction, which offers significant advantages in the back-lighting but also illumination of portions of a product display unit. A deflection of the direction of light propagation by an angle of 30 degrees, 45 degrees, 60 degrees, 75 degrees or 90 degrees has turned out to be of particular advantage. In general, however, the deflection of the direction of light propagation may also be accomplished by substantially 180 degrees, by means of which, for example, a back-lighting on the front side and rear side of the front module may be accomplished.

According to a further embodiment, the afore-mentioned coupling of light into the light guide plate may also be performed in the region of such a light-deflecting portion, for example, by positioning an LED strip or a linear LED array along the light-deflecting portion.

According to a further embodiment, the front module may be further configured such that the orientation and/or position of the light source relative to the front side or relative to the light-deflecting portion of the light guide plate may be varied for setting or adjusting the coupling of the light of the light source into the light guide plate, in order to selectively adjust the lighting conditions. For coupling-in the light from the light source via a light-deflecting portion of the light guide plate, particularly the ratio of the coupling of light into portions above and below the light-deflecting portion may be adjusted.

In general, the afore-mentioned front module may be connected with a portion for supporting products of a product display unit using any known connection techniques. In particular screw couplings have turned out to be of particular advantage for this purpose. According to a further embodiment, the front module is further configured to be releasably latched to the portion for supporting products, in particular at a front end thereof. For this purpose, latching elements, such as locking tabs and corresponding locking recesses, are provided on the front module and/or at the front edge of an associated portion for supporting products.

A particularly high energy efficiency can be achieved according to a further embodiment if the light source of the front module is a linear LED-array or an LED strip.

According to a further embodiment, additional covers for the LED light sources are not required to avoid bothersome scattering light, etc. in the region of the light sources and of the light coupling, if the linear LED-array or LED strip of the front module is accommodated in an LED housing portion, which extends along a front face of the light guide plate or along a light-deflecting portion formed by the light guide plate, i.e. if the LED housing portion can also serve as an enclosure or edge of the portion for supporting products, resulting in an even more compact structure.

According to a further embodiment, an even more compact and more flexible structure can be implemented, if the LED housing portion is connected to a carrier (support) of the front module or is formed therein, wherein the front module can be connected with the portion for supporting products via said carrier (support). The carrier may be connected over its entire width of the portion for supporting products with the front module or, for example, only at the sides of the front module.

According to a further embodiment, a particularly simple and inexpensive structure can be implemented if the afore-mentioned carrier (support) is formed as a transverse strut formed by cutting from a continuous profile. With an appropriate design of the support (carrier) as a continuous profile, the light guide plate of the front module can be held by friction or in a positive-fit manner on the latter. The continuous profile can simultaneously provide further stiffening of the module in the transverse direction.

According to a further embodiment, a particularly efficient light coupling can be implemented in a simple manner, when the light guide plate of the front module is supported on the afore-mentioned carrier (support) in such a manner that its end face faces the linear LED array or the LED strip and that a center line of a front portion of the light guide plate is aligned with an optical axis of the linear LED-array or LED strip.

According to a further embodiment, the light used for the back-lighting may be focused in a simple manner to specific portions by means of a cover, where the text information and/or graphics information is to be displayed. Thus, the attention of customers can be attracted in an advantageously simple manner to individual portions of the front module.

According to a further embodiment this effect can be implemented in a simple manner by means of a strip-like or frame-like cover, which comprises a coating, which extends along an upper and/or lower edge of the front side of the front module or which surrounds the front face in a frame-like manner in order to form a central portion for the back-lighting, which comprises the at least one opening or the at least one passage.

According to a further embodiment, an additional cover may be provided or the above-mentioned cover may be used to accommodate or hold a planar element, particularly a transparent plastic strip, on which the text information and/or graphics information to be displayed is provided, particularly printed on it.

According to a further embodiment, the front side of the front module is pivotally supported or the front module may be connected to the portion for supporting products in such a manner that the front module is pivotally supported on the portion for supporting products, so that a viewing angle onto the front side of the front module can be varied, wherein the inclination angle of the front side of the front module can be locked, in particular by means of the same locking elements or using a locking technique. The alignment can thus be suitably varied by pivoting or adjusting the front module and then be fixed without replacement of the front module.

According to a further embodiment the front module further comprises a receptacle having a rectangular profile, which is preferably designed as a test strip receptacle for accommodating the test strip for cosmetic products, wherein the receptacle is inserted in the front module. Thus, the ability for displaying cosmetics and cosmetic products can be significantly enhanced, because test strips, especially for fragrances or perfumes, can be reliably retained in the receptacle and can be stored at a prominent location for customers, namely at the front end of the front module.

According to a further aspect of the present invention there is provided a module for a product display unit for displaying products, in particular for displaying cosmetic products, comprising a portion for supporting products and a front module, as described above, which is disposed at the front end of the portion for supporting products, wherein the portion for supporting products has a supporting plate (shelf plate), which extends horizontally or substantially horizontally, for supporting or accommodating the products to be displayed and wherein the supporting plate (shelf plate) is provided at least in sections with a planar light guide plate that is associated with a light source whose light is coupled into an end face of the light guide plate, wherein the light guide plate is configured to provide a back-lighting function for the products to be displayed at least in sections.

Preferably, the light guide plate is configured in the same manner as disclosed above in connection with the front module. Despite the reduction of the total number of light sources to only two LEDs or LED strips (on the one hand, for the portion for supporting products, on the other hand, for the front module) according to the present invention an optimum or at least enhanced illumination of products can be ensured. By means of the back-lighting, which is emitted from or coupled out of the surface of the shelf plate, the products disposed on the shelf plate are uniformly illuminated from the bottom, in the manner of a surface illumination, and, if light is also coupled out of the underside of the shelf plate, as well products that are located below the shelf plate are uniformly illuminated from above, for example, products disposed on a further module of a display unit disposed below the module. By controlling the light sources the lighting conditions in the supporting portion and in the front module may be selectively set—even different from each other. At the same time, also a reduced power consumption can thus be achieved according to the invention.

For reliably supporting or accommodating the products by the portion for supporting products, this can be particularly shaped like a box, having raised side portions extending along the edges to prevent slippage of the products to be displayed. Or sleeve-like receptacles are provided or formed on the shelf plate (supporting plate), preferably made of a transparent or opaque material, in which the products to be displayed are reliably accommodated.

Preferably, the front module is detachably connected with the portion for supporting products, in particular by latching or a screw connection. Here, the front module can also be pivotally supported relative to the portion for supporting products, to vary or adjust the orientation of the front side of the front module relative to the portion for supporting products, which enables an even more effective displaying of products and associated text information and/or graphics information.

According to a further aspect of the present invention there is provided a products display unit for displaying or presenting products, in particular cosmetic products. This products display unit comprises at least one module as described above, which has a front module and a portion for supporting products at the front end of which the front module is provided, which is in particular connected with the latter.

According to a further embodiment, the supporting plate (shelf plate) is supported or mounted on a rectangular frame, which is connected to fixing portions by means of which the module can be fastened to a holding device. The fixing portions may be formed as L-shaped supporters, wherein a plurality of latching hooks are formed on a leg of the L-shaped supporter facing away from the supporting plate, which are mutually spaced under equal distances and which are configured to be hooked into holding openings of the holding device. Thus, the module can be hooked into or mounted to existing support struts of a product display unit in an advantageously simple manner.

The shelf plates/modules for the displaying of products, especially of cosmetic products, disclosed herein are characterized by an optimum utilization of light sources, preferably of LED strips, wherein the shelf plates/modules can be preferably attached by means of locking hooks of metal to the back wall of a display. The modules may have different sizes, shapes and colors, depending on the customer.

According to the invention the basic structure of each module can be that of a member made by plastic injection molding or by extrusion from a plastics material, which has latching hooks of metal at the rear end for inserting in a sales display. On this frame a plastic panel with area illumination or back-lighting (a transparent plastic plate illuminated by means of LEDs) is placed, which is used to illuminate the products. The front end of the shelf plate/module, also named shelfnose, preferably is made of a member formed by plastic injection molding having a curved plastic panel with surface illumination or back-lighting, as well as a text strip put on top of it. The shelfnose may be utilized in different variants; in particular in certain embodiments it may extend under an angle of 0°, 45° or 90°. Further angle variations are of course possible.

The afore-mentioned approach allows a reduction in the total number of illuminants required for back-lighting and as a result a reduction in power consumption, while improving the illumination of products.

On the one hand, an optimum illumination of products from above and below is ensured by the centrally disposed and surface-illuminated plastic plate. On the other hand, an optimum illumination of text strip profiles may be accomplished using the various embodiments of shelfnoses/modules of 0°, 45° and 90° orientation, depending on customers' needs.

### BRIEF OVERVIEW ON DRAWINGS

Hereinafter, the invention will be described in exemplary manner and with reference to the appended drawings, from which further features and advantages will become apparent to the person skilled in the art. In the drawings:

FIG. 1A shows a schematic cross-section of a module for a product display unit according to a first embodiment of the present invention;

FIG. 1b shows a front module of the module of FIG. 1a in a cross-sectional view;

FIG. 1C shows the module according to FIG. 1a in a perspective view;

FIG. 2A shows a schematic cross-section of a module for a product display unit according to a second embodiment of the present invention;

FIG. 2B shows a front module of the module of FIG. 2a in a cross-sectional view;

FIG. 2C shows the module according to FIG. 2a in a perspective view;

FIG. 3A shows a schematic cross-section of a module for a product display unit according to a third embodiment of the present invention;

FIG. 3B shows a front module of the module of FIG. 3a in a cross-sectional view;

FIG. 3C shows the module according to FIG. 3a in a perspective view;

FIG. 4 shows a product display unit having a plurality of modules for the displaying of products in accordance with the present invention, wherein the front modules are oriented in different directions;

FIGS. 5A-5C show the front modules according to further embodiments of the present invention;

FIG. 6A shows the connection of a front module having a portion for supporting products according to a further embodiment of the present invention; and

FIG. 6B shows the connection of a front module having a portion for supporting products according to a further embodiment of the present invention.

Throughout the drawings, identical reference numerals designate identical or substantially equivalent elements or groups of elements.

### DETAILED DESCRIPTION OF PREFERRED EMBODIMENTS

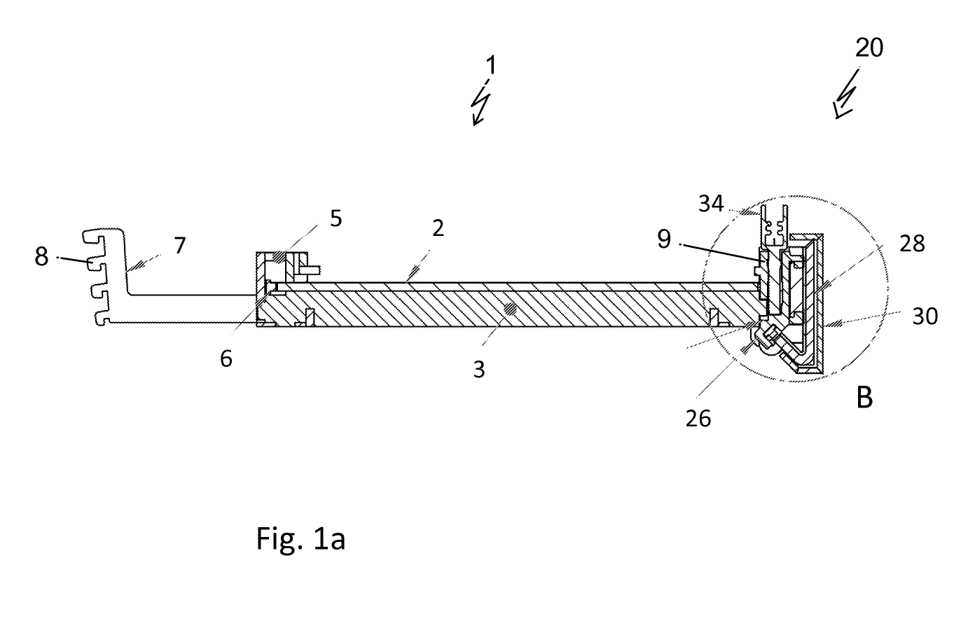

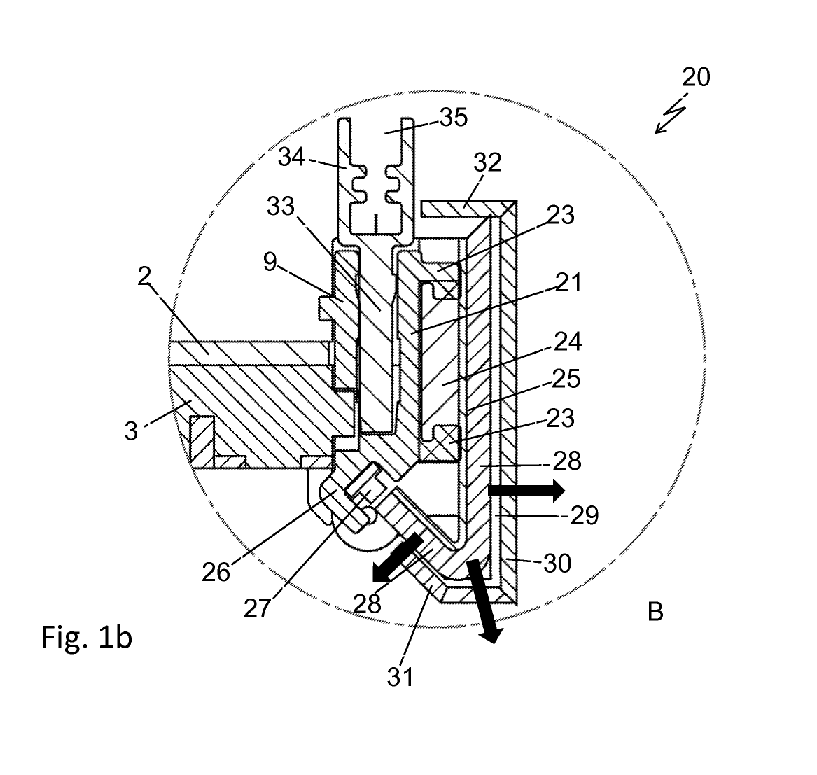

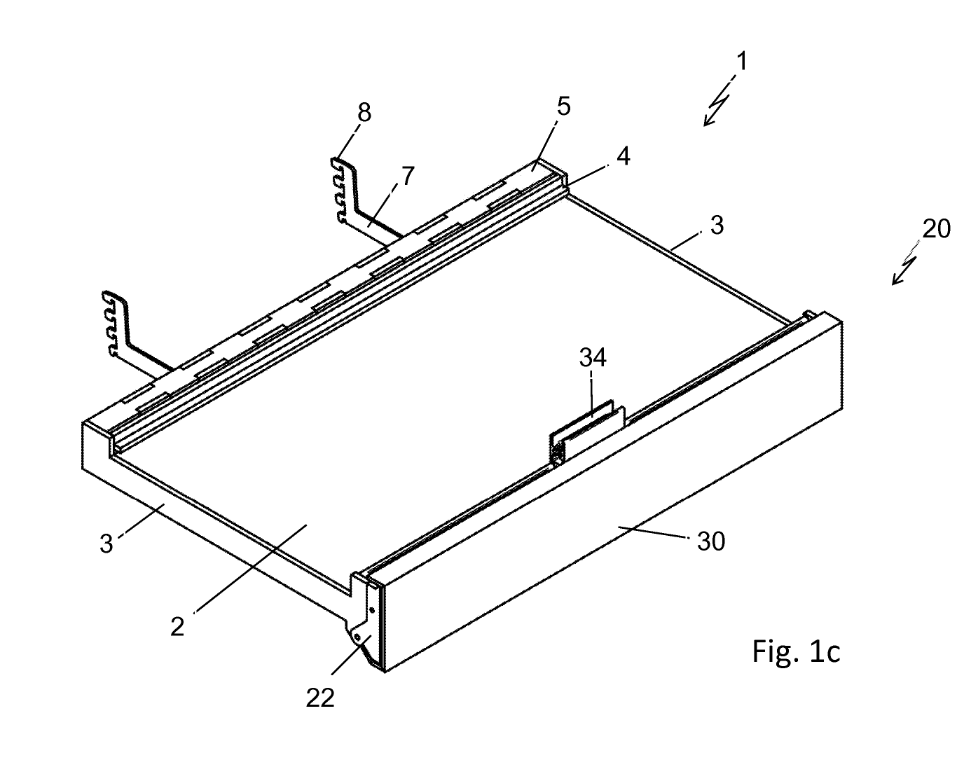

Hereinafter, a first embodiment of a module for a product display unit (a unit for displaying products) will be described with reference to FIGS. 1a-1c, which generally comprises a portion 1 for supporting products and a front module 20, which is connected thereto or formed integrally therewith. The module is configured generally in the manner of a shelf board and serves for the supporting of products to be displayed. For this purpose, the shelf plate or supporting plate 2 of the portion 1 for supporting products is supported on a frame comprising the two side parts 3, a rear cross member 5 and a front module 20, which serves as a front edge member and which is shown in FIG. 1b on an enlarged scale. The rear cross member 5 and the front module 20 project from the plane which is defined by the supporting plate 2, so that the products cannot slip off accidentally. The side parts 3 may also be extended upward. The frame of the module may be integrally formed. Conveniently, however, the afore-mentioned frame parts are connected to each other or put together. The supporting plate 2 serves as a portion for supporting products in the sense of the present application, which is generally designated by reference numeral 1, and is made of a transparent plastic material, which is provided with structures for coupling-out light, as described above, which serves as a light guide plate and thus is provided with a back-lighting function, so that products disposed above and/or beneath the supporting plate 2 can be illuminated. In the latter case, the rear side of the supporting plate 2 is substantially not covered by support structures or frame components.

Conveniently, the supporting plate 2 is formed by injection molding or extrusion from a plastics material, either as a separate component or integrally together with portions of the frame or with the whole frame portion of the portion 1 for supporting products.

Further details of the construction of the module and of the coupling of light into the light guide plate of the portion 1 for supporting products and of the front module 20 are shown in the cross-sectional view of FIG. 1a and in the enlarged partial cross-sectional view of the front module 20 of FIG. 1b.

Referring to FIG. 1b, the portion for supporting products is terminated at the front end by an upstanding transverse strut 9, which either is part of the portion for supporting products or is part of the frontal module 20. Conveniently, the front module 20 is connected with the portion for supporting products, but may also be a part of the portion for supporting products and be held on an extension of the side part 3 to this end. The front module 20 comprises a carrier 21 configured as a transverse strut, which is preferably formed of a continuous profile, for example, of an extruded plastic profile or an extruded aluminum profile cut to a given length. Alternatively, the carrier 21 may be formed of a plurality of latching elements and supporting elements, which are arranged along the front end of the portion 1 for supporting products at regular intervals and in which a respective adapter 24 is latched or hooked, which is configured in correspondence to the latching elements or supporting elements, as shown in FIG. 1b. At the lower edge 26 of the carrier 21 a transverse recess is formed, in which an LED strip 27 or a plurality of LEDs 27 is (are) accommodated in a suitable configuration and which thus serves as an LED housing portion. In the exemplary embodiment shown in the drawing, the optical axis of the LED strip 27 is inclined with respect to the horizontal supporting plate 2 downward by an angle of 45 degrees and is aligned with the center line of the front end of the light guide plate 28, which—as well as the supporting plate (shelf plate) 2—is formed from a transparent plastic material. Thus, the light emitted from the LED strip 27 is coupled into the end face of the light guide plate 28.

The light guide plate 28 has a light-deflecting portion, e.g. formed by bending or by integral injection molding or extrusion of the light guide plate 28. At the light-deflecting portion the light guided in the light guide plate 28 is deflected in a different direction, namely, in the illustrated embodiment, in a direction perpendicularly upward. The front side and/or rear side of the light guide plate 28 is suitably formed in the manner described above, so that the light is coupled out at appropriate locations for providing the back-lighting function. Suitably, this coupling-out takes place homogeneously distributed over the entire surface of the light guide plate 28, especially also in the region of the light-deflecting portion, as indicated in FIG. 1b by the double arrow in this region. However, the back-lighting may also be accomplished by a partially different design of the light guide plate 28, even only in sections. As indicated by the double arrows in FIG. 1b, which indicate the light coupled-out, this view shows a homogeneous coupling-out over the entire surface of the light guide plate 28.

At the front of the carrier 21 two locking projections 23 are formed, in particular embodied as locking noses or supporting noses, so that an adapter 24 formed as a transverse strut is positively retained by them. The light guide plate 28 is held by the adapter 24. At this instance, the back of the light guide plate 28 may also be covered at least in sections with a coating 25, e.g. for connecting to the carrier 21 or the adapter 24

The front side of the light guide plate 28 is covered by a cover having at least one opening or passage for the backlight, in which the text and/or graphics information is displayed by means of the back-lighting. The cover 30 is preferably formed as a plastic strip, which may be covered on its surface, at least in sections, with a coating, in particular a metallization. Such a coating may extend, for example, along a top edge and/or bottom edge of the front side of the front module 20 or may surrounded the front end like a frame, in order to form a central portion having the at least one opening or the at least one passage for the back-lighting. For the displaying of text and/or graphics information particularly a transparent plastic strip may be arranged in front of the respective opening or passage, on which the text and/or graphics information is provided, in particular by printing, so that the information to be displayed is backlit by the out-coupled light.

The cover 30 itself may also be formed as a flexible plastic profile, the front end of which embraces the front end of the bent portion of the light guide plate 30—in the region of the LED housing portion 26—and the rear end of which embraces the upper edge of the light guide plate 28. In particular, the cover 30 can be clipped directly on the light guide plate 30 or supported by side panels 22 of the front module (see FIG. 1c).

In the illustrated embodiment, as shown in FIG. 1b, the light is coupled out uniformly into the directions indicated by the double arrows, which thus not only illuminates the front end of the front module 20 but also regions below and obliquely below the front module 20.

According to FIG. 1b a clearance is provided between the transverse strut 9 and the carrier 21, into which a supporting web 33 is inserted or clipped, at an upper end of which two lateral webs 34 form a receptacle 35 for receiving, for example, text strips, caption labels or products price tags, or which serves, according to a preferred embodiment, as a receptacle or support of cosmetic test strips.

FIG. 1c shows the complete shelf plate/module, as it will be mounted later into the product display units.

According to FIG. 1a, the frame of the module is connected to fixing portions 7, which are formed as L-profiles in the illustrated embodiment and which serve to fix the module on a holding device. Preferably, a plurality of mutually equally spaced latching hooks 8 are provided on the shorter leg of the L-profiles 7, which can be hooked into the holding openings of a support bar. In this way, a simple vertical adjustment of the module can be implemented.

Furthermore, a box-shaped LED-receiving portion 5 is also provided at the rear end of the shelf plate (supporting plate) 2, which accommodates an LED strip or a plurality of LEDs in a suitable arrangement, which extend(s) in a transverse direction. The power supply for the LED lighting units 6, 27 may be supplied directly via mounting portions 7 made of metal or via cables that extend along these mounting portions 7.

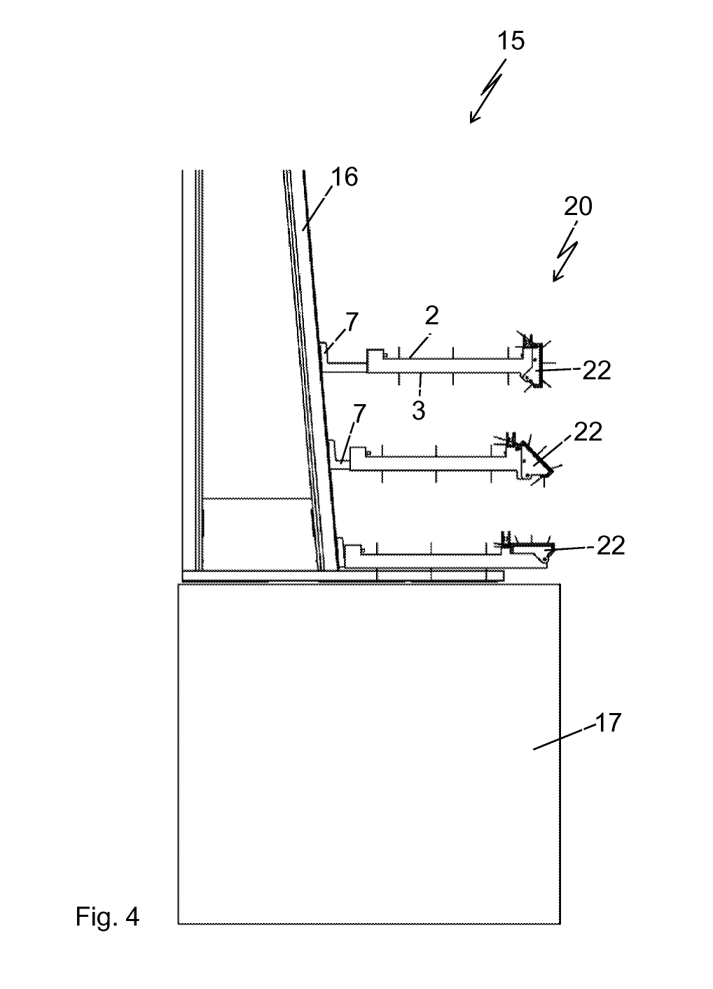

FIG. 4 shows a product display unit 15 for the displaying of cosmetic products, comprising three modules 1 of the type as described above, which are each composed of a portion 1 for supporting products and of a front module 20 connected thereto. These modules 1 are hooked into support struts 16 via the L-profiles 7 and latching hooks provided thereon. The product display unit 15 further comprises a box-shaped base body 17, which may serve for the storage of other products but also for the storage of electronic components, particularly transformers, batteries or switching units for the LED lighting units.

As will become apparent to a person skilled in the art when studying FIG. 4, the modules 1 can be also connected in a different manner with a supporting structure or suspended in a supporting structure. For example, the supporting structure can be configured as a carcass, into which the modules 1 are directly screwed or plugged.

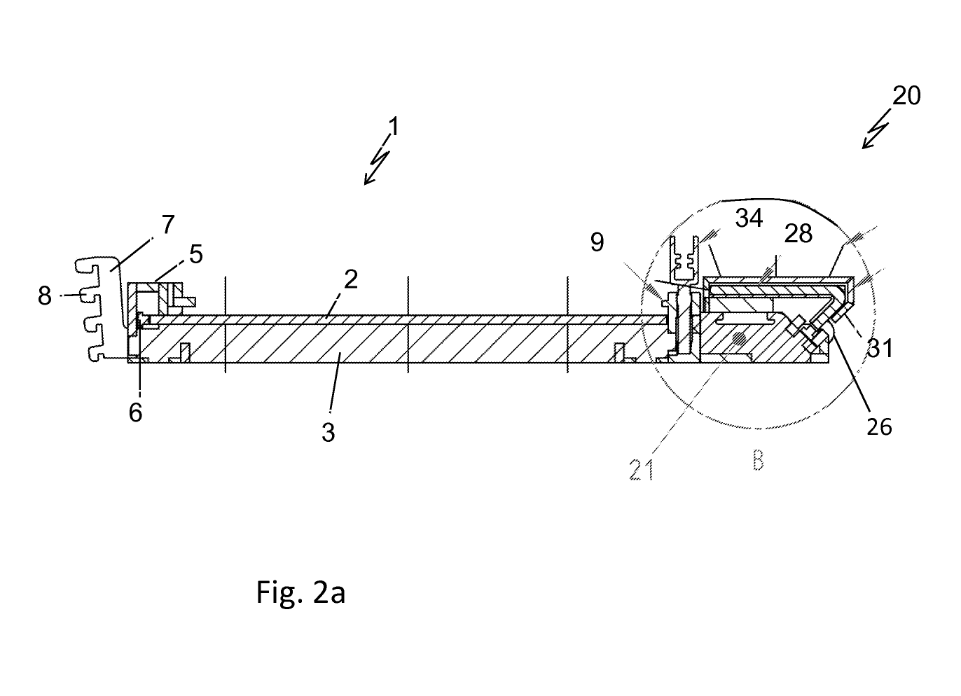

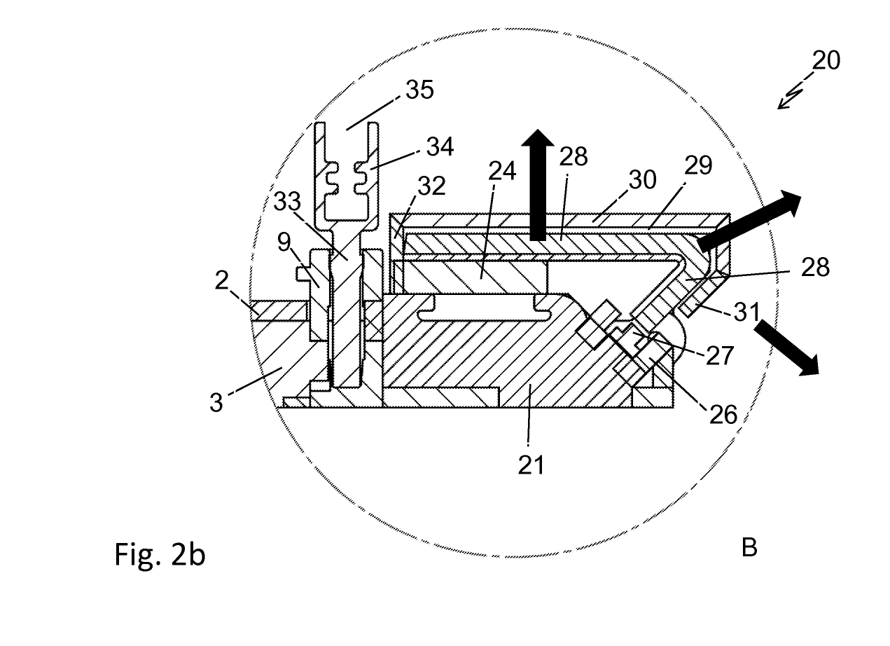

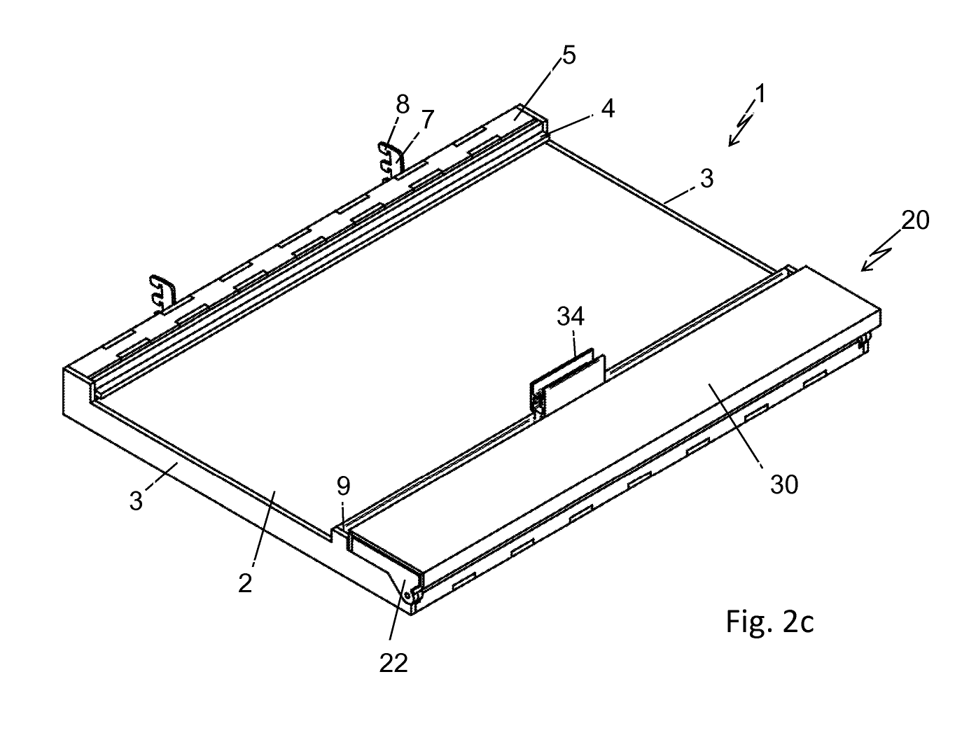

FIGS. 2a-2c, 3a-3c and 4a-4c show further variants of the module described above. According to FIGS. 2a-2c, the front side of the front module 20 is aligned substantially in parallel with the horizontal supporting plate 2, which—in comparison—only requires a simple support profile 21 of a different design. The double arrows in FIG. 2b indicate the direction of propagation of the light coupled out from the light guide plate 28. Thus, in this embodiment the light is emitted mainly vertically upwards, but also horizontally forward and obliquely downward.

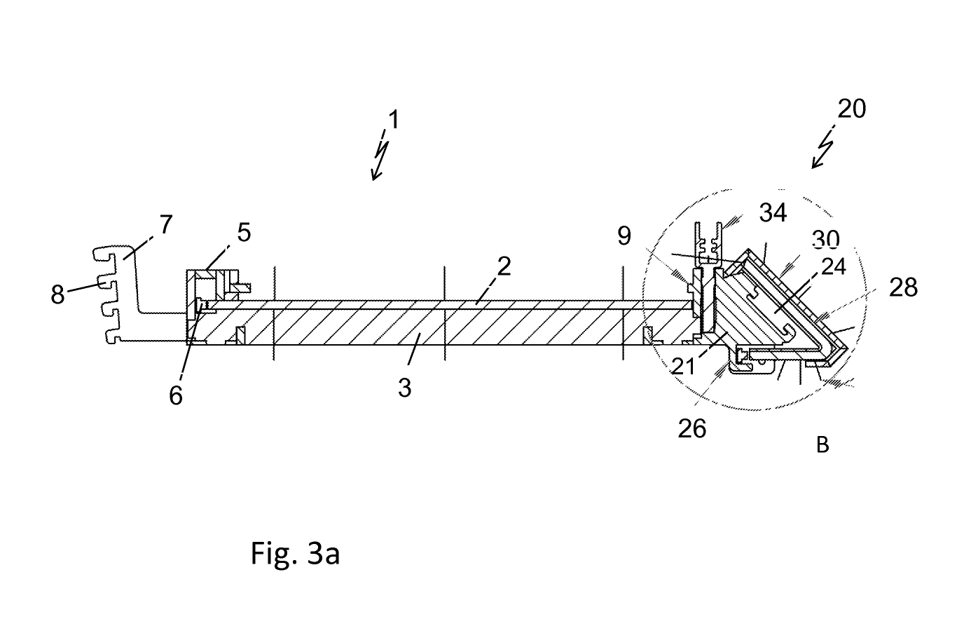

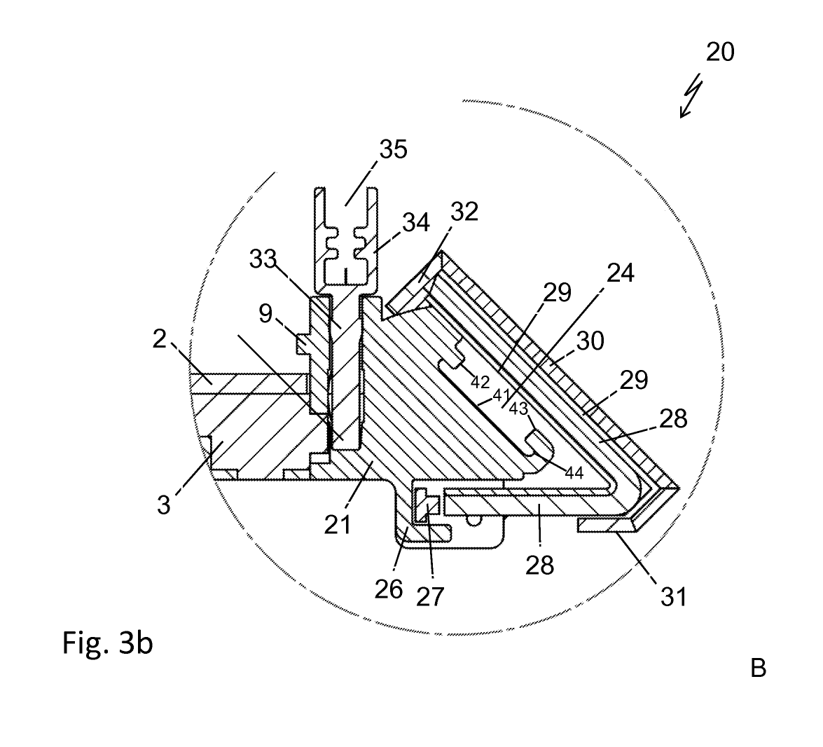

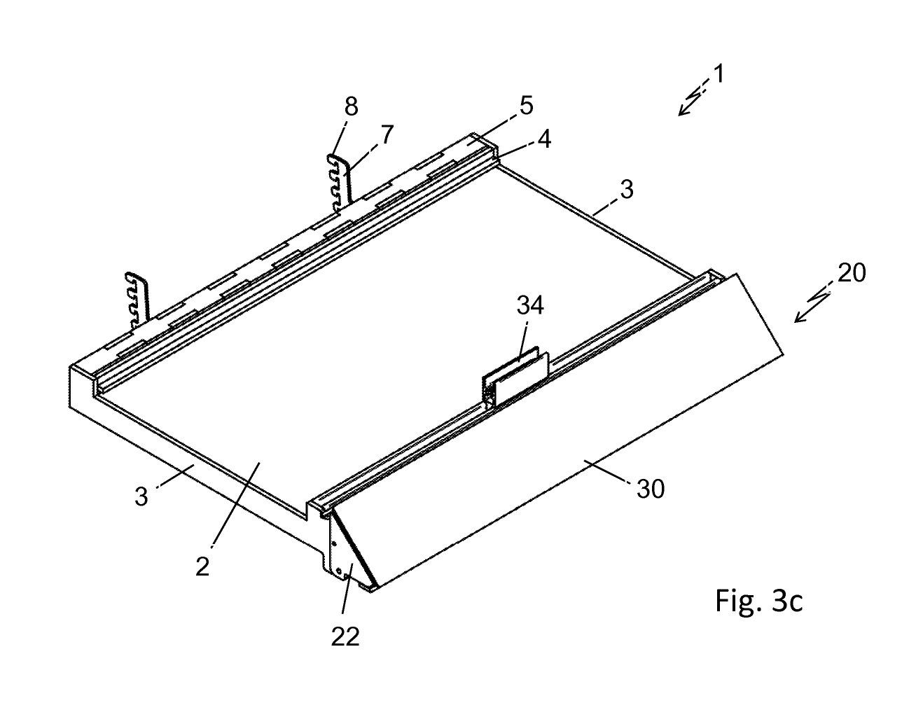

According to FIGS. 3a-3c the front side of the front module 20 extends substantially at an angle of 45 degrees relative to the horizontal supporting plate 2, which—in comparison—only requires a simple support profile 21 of a different design. The double arrows in FIG. 3b indicate the direction of propagation the light coupled out from the light guide plate 28. Thus, in this embodiment the light is emitted predominantly at an angle of 45 degrees obliquely upwards, but also vertically downward.

According to FIGS. 2a-2c, the front side of the front module 20 is aligned substantially in parallel with the horizontal supporting plate 2, which—in comparison—only requires a simple support profile 21 of a different design. The double arrows in FIG. 2b indicate the direction of propagation of the light coupled out from the light guide plate 28. Thus, in this embodiment the light is emitted mainly vertically upwards, but also horizontally forward and obliquely downward.

As will be readily appreciated by the person skilled in the art, in this manner any other angle can be implemented, under which the front side of the front module 20 is aligned with respect to the horizontal supporting plate 2.

As becomes apparent from FIG. 4, by means of the module according to the present invention the illumination conditions in a product display unit can be adjusted very variably and individually, as indicated by the black lines 20 projecting from the front module. For example, the front module 30 of the bottom module is arranged in parallel with the horizontal supporting plate 2 so that light is emitted substantially only upward from the front surface, whereas the front module 20 of the middle module is inclined by an angle of about 45 degrees relative to the supporting plate 2 so that light is emitted both inclined upward and vertically downward from the front surface of the front module 20, whereas the front module 20 of the uppermost module is perpendicular relative to the supporting plate 2, so that the light is emitted substantially only horizontally forwards from the front side of the front module 20, i.e. toward the customers, namely is emitted also obliquely downward and inward. By varying the angle of inclination of the front module 20, these lighting conditions can be varied in a simple manner.

In order to accomplish an even greater flexibility, according to a further embodiment (not shown) the front side of the front module 20 may be also pivotally supported, so that the viewing angle onto the front side of the front module 20 may be varied. Here, the inclination angle of the front side of the front module 20 preferably can be locked, in particular by means of locking members (screws or the like) thereof, or by means of locking.

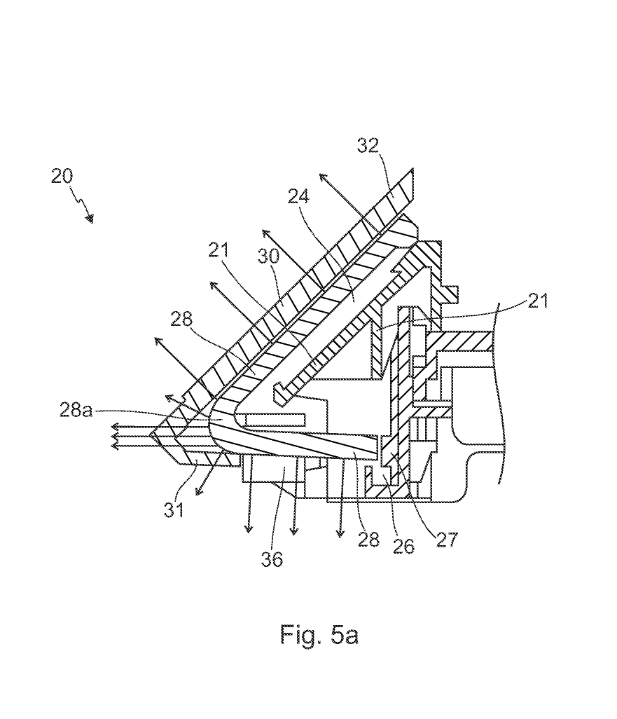

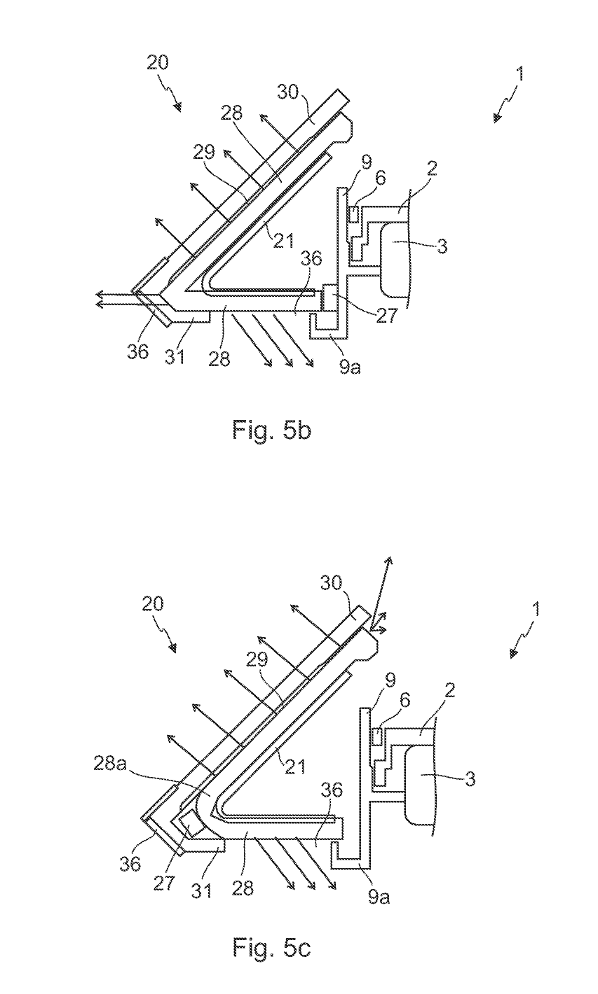

FIG. 5a shows a front module 20 according to a further embodiment of the present invention. Light emitted from the LED strips 27 and coupled into the light guide plate 28 via the end face, propagates within the light guide plate 28, is deflected in the region of the light-deflecting portion 28a in a different direction, namely, by an angle of about 135 degrees, and is guided further within the upper portion of the light guide plate 28. As indicated by the arrows in FIG. 5a, the light is uniformly coupled out from the front side of the light guide plate 28 and is emitted at a right angle relative to the surface of the light guide plate 28 by the latter. In the non-curved portions of the light guide plate 28, thus the light is emitted vertically downwards or at an angle of about 45 degrees upward and forward. Furthermore, the light is also coupled out from the light deflecting portion 28a, particularly toward the front side in the direction of an observer. The coupling-out of light may also always be accomplished in the region of the light-deflecting portion 28a, in particular perpendicular to the local surface. If the coupling-out of light should be considered as bothersome in the region of the light-deflecting portion 28a, a cover for blocking or at least for attenuating the out-coupled light may be provided in this area.

FIG. 5b shows a front module 20 according to a further embodiment of the present invention. By means of a suitable design of the light guide plate 28, the light is emitted under an acute angle of about 45 degrees and backward on the underside of the front module 20. This effect can be utilized for the illumination of products or portions disposed underneath a product display unit. In the region of the light-deflecting portion at the front end of the front module 20 a cover 36 is provided, which blocks or at least attenuates the light coupled out in this area as desired.

FIG. 5c shows a front module 20 according to a further embodiment of the present invention. Different from FIGS. 5a and 5b, the light of the LED strip 27 is coupled uniformly into the lower and upper portion of the light guide plate 28 via the light deflecting portion 28a, from where the light is irradiated again in the manner as described above, as indicated by the arrows. The coupling is done expediently in such a manner, that about equal amounts of light are coupled into the portion of the light guide plate 28 extending obliquely upward and into the horizontal portion of the light guide plate 28, from where the light is again coupled out. According to a further embodiment (not shown), the orientation and/or position of the LED strip 27 relative to the light-deflecting portion 28a may also be adjusted for varying the afore-mentioned amounts of light that are coupled into the portion of the light guide plate 28 extending obliquely upward and into the horizontal portion of the light guide plate 28. To this end the LED strip 27 may be pivotally supported relative to the light-deflecting portion 28a.

According to a further embodiment (not shown), according to which the light is coupled into the light guide plate via the end face thereof, an LED strip may be pivotally supported relative to its end surface in the same manner in order to optimize or suitably adjust the efficiency of coupling the light into the light guide plate.

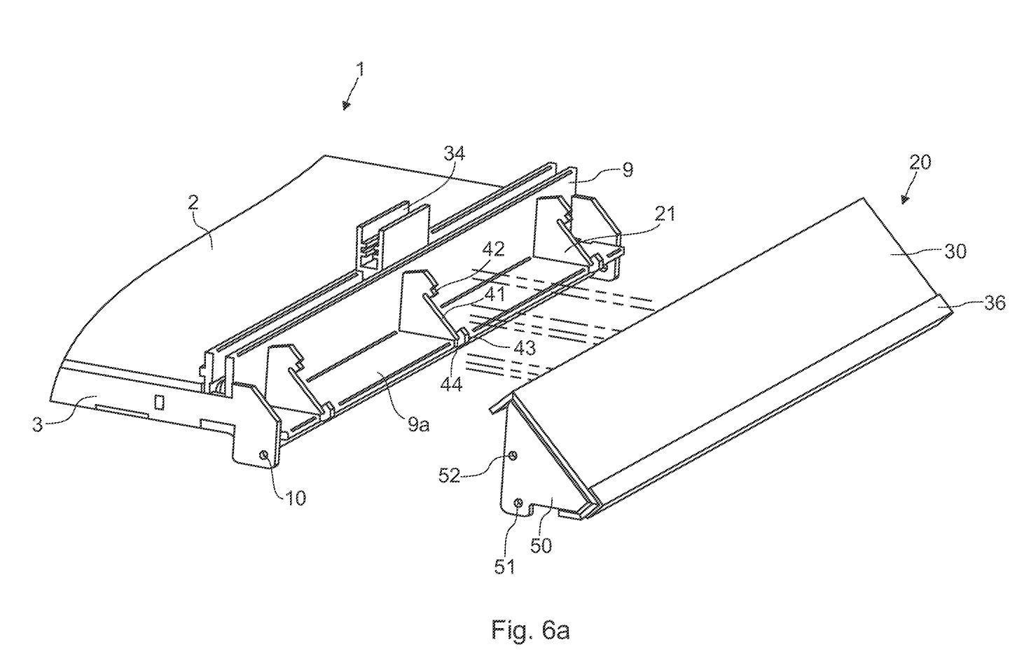

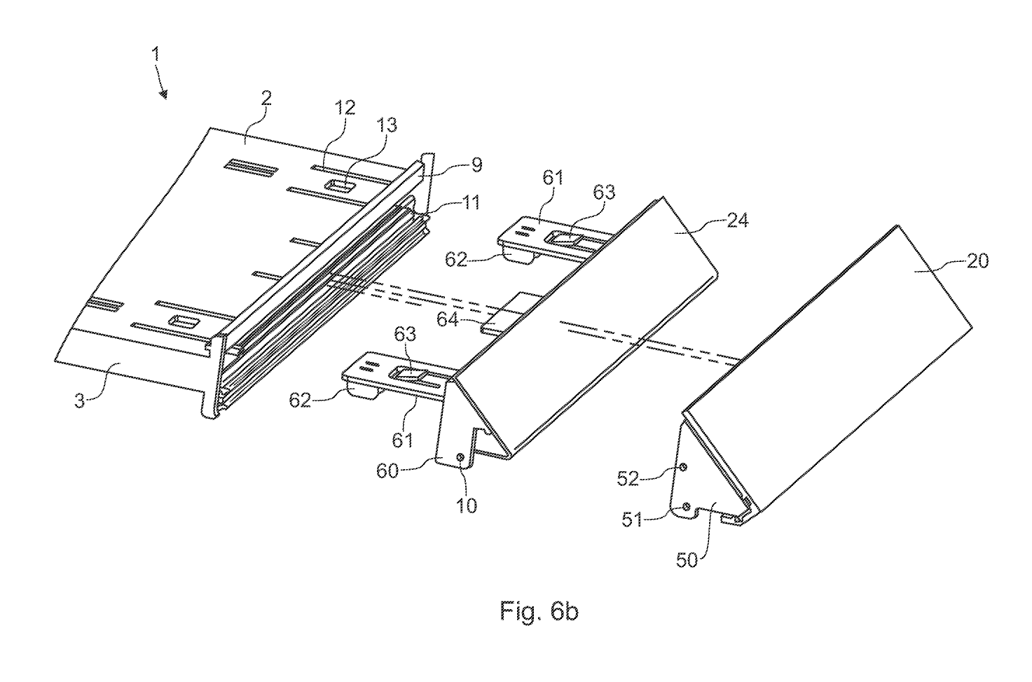

FIG. 6a shows the coupling of a front module 20 with a portion 1 for supporting products in accordance with a further embodiment of the present invention. According to FIG. 6a, the front edge 9a of the portion 1 for supporting products is extended horizontally and forms, together with the front side of the cross strut 9, a rectangular receptacle, which is limited laterally by the front ends of the frame side parts 3 of the portion 1 for supporting products. In this receptacle a plurality of supporting members or locking members 40 are provided at regular spacings along the front edge 9a of the portion 1 for supporting products, which are each formed as flat members made of metal or plastic. These members each have a bevel 41, which is delimited by an upper retaining nose 42 and a lower retaining projection 43, respectively. Between the bevel 41 and the upper retaining nose 42 and the lower retaining lug 43, respectively, a recess 44 is formed, which is engaged with (particularly hooked into) a correspondingly formed coupling member or latching element (not shown) on the rear of the front module 20 in a positively-fit manner. In this manner, the front module 20 can be coupled to the front end of the portion 1 for supporting products.

The front module 20 comprises two side covers 50, in which an aperture 51 is formed, which serves as a rotation axis. Corresponding openings 10 are also formed at the front end of the frame side parts 3 of the portion 1 for supporting products. Pins, bolts, screws or similar connecting elements can be engaged into these openings 10, 51 so that the front module 20 can be pivoted relative to the portion 1 for supporting products about a rotation axis formed by said pin, bolt, screw or the like. The desired orientation of the front module 20 can be locked finally by means of a fixing element 52, e.g. by means of a locking screw. In order to ensure a sufficient pivoting movement of the front module 20, the size of the aperture 44 may be suitably adapted to that of the connecting element or locking element (not shown) on the rear side of the front module 20.

According to a further embodiment, the afore-mentioned pivotable support of the front module is not provided. Rather, the front module is directly hooked into the connecting element or locking element (not shown) on the rear side of the front module 20 and the connection is secured by means of the locking element 52.

FIG. 6b shows the connection of a front module, having a portion for supporting products according to a further embodiment of the present invention. According to FIG. 6b an opening 11 is formed in the transverse strut 9 at the front edge of the portion 1 for supporting products, into which the projections 61 can be inserted, which are formed on the rear side of the adapter 24 of the front module 20. More specifically, each of the projections 61 comprises a sliding shoe 62 on its underside, which can slide on the inside of the bottom of the portion 1 for supporting products for guiding the adapter 24 while it is connected with the portion 1 for supporting products. For guiding the adapter 24, guide slots 12 are also formed in the plastic plate 2, which cooperate positively with the extensions 61. Furthermore, elastic latching lugs 63 are formed on the projections 61, which can engage in corresponding openings 13 or recesses in the plastic plate 2. Thus, by means of the adapter 24 the front module 20 can be detachably connected to the portion 1 for supporting products. The orientation of the adapter 24 relative to the portion 1 for supporting products can still be fixed by means of a guide tab 64.

In order to adjust the orientation of the front side of the front module 20 by pivoting of the front module 20, apertures 10 and 51 are formed on the sides 60 or 50 of the adapter 24 and of the front module 20, respectively, in the manner described above, which can engage with the pins, bolts, screws or similar connecting elements. The desired orientation of the front module 20 can be locked finally by means of a fixing element 52, e.g. by means of a locking screw.

As will become readily apparent to the person skilled in the art upon studying the above description, the shelf plate (or supporting plate) of portion for supporting products does not necessarily need not be positioned exactly horizontally. Rather, it can also be arranged inclined, e.g. inclined obliquely downward toward the front end of product display unit. As will become readily apparent to the person skilled in the art upon studying the above description, the features described above may also be combined with each other in other ways than specifically disclosed above. Thus, the scope of protection of the appended claims shall be based on a rather broad interpretation. As will become readily apparent to the person skilled in the art upon studying the above description, further modifications may be performed which are to be covered by the appended claims, provided they continue to fall under the general spirit of the invention and the scope of protection of the appended claims.

### LIST OF REFERENCE NUMERALS

1 shelf plate/portion for supporting products
2 plastic plate
3 side part of frame
4 stop
5 rear LED housing
6 LEDs/strip of LEDs
7 Mounting portion
8 latching hook
9 transverse strut
9a bottom edge of portion 1 for supporting products
10 axis of rotation of front module
11 opening
12 guide slot
13 recess
15 product display unit
16 mounting strut
17 base body
20 front module
21 carrier
22 side part
23 projection
24 adapter
25 intermediate layer
26 front LED housing
27 LEDs/strip of LEDs
28 plastic plate/light guide plate
28a light deflecting portion
29 gap
30 cover
31 front end of cover
32 rear end of cover
33 supporting web
34 lateral web/tab
35 receptacle for labeling
36 cover
40 latching or supporting member
41 bevel
42 upper retaining lug
43 lower retaining lug
44 recess
50 lateral cover of front module
51 axis of rotation of front module
52 locking member for front module
60 lateral member of adapter 24
61 extension
62 slide show
63 locking tab
64 guide tab

1. A front module for a portion for supporting products of a product display unit, wherein the front module is configured to be disposed at the front end of the portion for supporting products,
said front module having a front side configured for displaying text and/or graphics information for customers,
wherein said front module comprises a planar light guide plate having a light source associated to it so that light from the light source is coupled into the light guide plate, wherein the light guide plate is configured to provide a back-lighting for said text and/or graphics information at least in sections at the front side of said front module.

2. The front module as claimed in claim 1, wherein said front module is configured furthermore to delimit the portion for supporting products at least in sections and is configured to be connected with the portion for supporting products, wherein the front module protrudes from a plane spanned by the portion for supporting products for preventing slippage of products from the portion for supporting products.

3. The front module as claimed in claim 1, wherein the light guide plate extends in at least one region in a different direction to form at least one light deflecting portion for deflecting the light coupled into the light guide plate into another direction of propagation.

4. The front module as claimed in claim 3, wherein the light from the light source is coupled into an end face of the light guide plate or into a light deflecting portion formed by said light guide plate.

5. The front module as claimed in claim 4, wherein the orientation and/or position of the light source relative to the end face or the light deflecting portion of the light guide plate can be changed for adjusting or matching the coupling of light of the light source into the light guide plate.

6. The front module as claimed in claim 1, said front module being configured furthermore to be latched or locked with the portion for supporting products.

7. The front module as claimed in claim 1, wherein the light source is a linear LED array or a strip of LEDs, wherein the linear LED array or strip of LEDs of said front module is accommodated in an LED housing portion extending along an end face of the light guide plate or along a light-deflecting portion formed by the light guide plate.

8. The front module as claimed in claim 7, wherein said LED housing portion is connected to a carrier of said front module or formed therein and wherein the front module can be connected to the portion for supporting products via said carrier.

9. The front module as claimed in claim 8, wherein the carrier is formed as a transverse strut formed by cutting a continuous profile.

10. The front module as claimed in claim 8, wherein the light guide plate of the front module is supported at the carrier in such a manner that the end face faces toward the linear LED array or of the strip of LEDs and that a center line of a front portion of the light guide plate is aligned with an optical axis of the linear LED array or of the strip of LEDs.

11. The front module as claimed in claim 8, wherein a front end of the light guide plate of the front module, which faces toward the linear LED array or strip of LEDs, is bent relative to the front side of the front module.

12. The front module as claimed in claim 11, wherein the surface of the light guide plate of the front module is configured in such a manner that light is uniformly coupled out from a surface of the light guide plate facing toward the front side for providing the back-lighting function.

13. The front module as claimed in claim 1, wherein the surface of the light guide plate of the front module is configured at least in sections in such a manner that light is coupled out of the light guide plate at least in sections under an acute angle relative to the surface of the light guide plate for providing the back-lighting function.

14. The front module as claimed in claim 1, wherein the front side of the front module is covered at least in sections by a cover, which comprises at least one opening or at least one passage for the back-lighting, in which the text and/or graphics information is displayed by means of the back-lighting, wherein the cover is provided at least in sections with a coating, wherein said coating extends along an upper and/or lower edge of the front side of the front module or wherein said coating surrounds said front side in a frame-like manner for forming a central portion having said at least one opening or said at least one passage for the back-lighting.

15. The front module as claimed in claim 1, wherein the front side of the front module is covered at least in sections by a cover, which is transparent for the back-lighting, wherein the cover comprises a planar member formed as a transparent plastic strip, on which the text and/or graphics information to be displayed is provided.

16. The front module as claimed in claim 1, wherein the front side of the front module is pivotally supported or wherein the front module can be connected with the portion for supporting products in such a manner that the front module is pivotally mounted thereon, so that a viewing angle onto the front side of the front module can be varied, wherein the angle of inclination of the front side of the front module can be locked.

17. The front module as claimed in claim 1, said front module further comprising a rectangular receptacle configured as a receptacle for receiving a test strip for cosmetics, wherein the receptacle is inserted into the front module.

18. The front module as claimed in claim 1, wherein the light guide plate is formed of a transparent plastic material selected from a group consisting of epoxy resin, polycarbonate and polymethyl methacrylate (PMMA).

19. A module for a product display unit, in particular for displaying cosmetic products, comprising
a portion for supporting products, and
a front module provided at the front end of the portion for supporting products, said front module having a front side configured for displaying text and/or graphics information for customers
wherein said portion for supporting products comprises a horizontal shelf plate for supporting or receiving products to be displayed, and wherein the shelf plate comprises at least in sections a planar light guide plate having a light source associated thereto, wherein light of the light source is coupled into a front face of the light guide plate and wherein the light guide plate is configured to provide a back-lighting function for the products to be displayed at least in sections,
wherein the light guide plate is further configured to provide a back-lighting function for said text and/or graphics information at least in sections at the front side of said front module.

20. The module for a product display unit as claimed in claim 19, wherein the front module is releasably coupled to said portion for supporting products by latching, and/or wherein the front module can be pivoted relative to the portion for supporting products for varying or adjusting the orientation of the front side of the front module relative to the portion for supporting products.

21. A product display unit for cosmetic products, comprising at least one module, which comprises:
a portion for supporting products, and
a front module provided at the front end of the portion for supporting products, said front module having a front side configured for displaying text and/or graphics information for customers
wherein said portion for supporting products comprises a horizontal shelf plate for supporting or receiving products to be displayed, and wherein the shelf plate comprises at least in sections a planar light guide plate having a light source associated thereto, wherein light of the light source is coupled into a front face of the light guide plate and wherein the light guide plate is configured to provide a back-lighting function for the products to be displayed at least in sections,
wherein the light guide plate is further configured to provide a back-lighting function for said text and/or graphics information at least in sections at the front side of said front module.

22. The product display unit as claimed in claim 21, wherein the front side of the front module is inclined with respect to a plane spanned by the horizontal shelf plate of the portion for supporting products under an angle of 30 degrees, 45 degrees, 60 degrees, 75 degrees or 90 degrees or extends in parallel therewith.

23. The product display unit as claimed in claim 22, wherein the shelf plate is supported or mounted on a rectangular frame, which is connected to fixing portions and wherein the module can be fastened to a holding device via said fixing portions.

24. The product display unit as claimed in claim 23, wherein the fixing portions are formed as L-shaped carriers, wherein a plurality of latching hooks are formed on a leg of the L-shaped carrier facing away from the shelf, said latching hooks being spaced apart at equidistant spacings and being configured to be hooked into holding openings of the holding device.

25. The product display unit as claimed in claim 21, further comprising a box-shaped base body and a holding device, on which the modules are mounted, wherein the holding device comprises a plurality of vertical support struts or a plurality of support struts, which are inclined relative to a vertical direction, and wherein a plurality of holding openings are formed in said vertical or inclined support struts at equidistant spacings, into which the modules are mounted.
